(19) United States
(12) Patent Application Publication
(10) Pub. No.: US 2021/0156621 A1
(43) Pub. Date: May 27, 2021

(54) HEAT STORAGE TANK OPTIMISED USING CALCIUM CARBONATE PARTICLES

(71) Applicant: Arkema France, Colombes (FR)

(72) Inventors: Jérôme Blanc, Brignais (FR); Pierre Larnicol, Verriere le Buisson (FR)

(73) Assignee: Arkema France, Colombes (FR)

(21) Appl. No.: 16/624,537

(22) PCT Filed: Jun. 21, 2018
(86) PCT No.: PCT/FR2018/051508

§ 371 Date: Dec. 19, 2019

(30) Foreign Application Priority Data
Jun. 21, 2017 (FR) 1755667

(51) Int. Cl. F28D 20/00

(52) U.S. Cl. CPC F28D 20/0056; F28D 2020/0047; F28D 2020/0021

(57) ABSTRACT

Provided is a heat storage tank including at least one chemically inert solid heat storage material containing at least calcium carbonate particles, in which the calcium carbonate particles have a size distribution with a diameter d50 of from 0.5 mm to 200 mm.

The present invention relates to a heat storage tank including at least one chemically inert solid heat storage material containing at least calcium carbonate particles.

The invention also relates to the use of at least one chemically inert solid heat storage material including at least calcium carbonate particles for limiting the rate of degradation of a heat-transfer fluid that is capable of circulating in a heat storage tank.

The invention also relates to a facility for recovering free heat of industrial origin including at least one storage tank containing at least one heat-transfer liquid and at least one chemically inert solid heat storage material including at least calcium carbonate particles.

The invention also relates to a solar power plant including at least one heat storage tank containing at least one heat-transfer liquid and at least one chemically inert solid heat storage material including at least calcium carbonate particles.

Energy transition is one of the major challenges of our century since it denotes the passage from the current energy system using non-renewable resources such as oil, natural gas, coal, and radioactive materials such as uranium and plutonium, to a system based mainly on renewable resources, such as biomass, and renewable energy sources such as hydraulic, wind, solar or geothermal energy.

Among these renewable energies, some of them have a production which proves to be irregular and intermittent. Energy storage is thus, in this case, a technology for increasing their use and constitutes a central feature of energy transition on account of its flexibility and its efficiency. It makes it possible not only to better upgrade the energy, but also to better dimension our future equipment, both for production and for consumption.

“Conventional” energy storage technologies (pumping, batteries, hydrogen, compressed air) generally have in common the often very high starting investment cost of the storage facility. Furthermore, the geographical impact of projects involving a turbine pumping system (also known as PETS: pumped energy transfer stations), associated with hydraulic energy, or for storing compressed air in a cavity (also known as CAES: compressed air energy storage) is important, on account of the size of the facilities involved, and the possible number of implantation sites may prove to be limited.

Heat is a form of energy that is capable of being stored very easily at low cost, notably at low temperature, and its storage mainly allows the heating of buildings, which represents a large proportion of the energy consumption in Europe. Moreover, heat storage may also improve the functioning and service life of solar power plants, in particular concentrated thermodynamic solar power plants (known as CSP: concentrated solar power).

Heat sources originate firstly from solar energy, which is, by its nature, of intermittent (for example difference between day and night or between summer and winter), diluted and random character (notably on account of unpredictable cloud passages), which renders its production out of step with daily or seasonal energy demand. The aim of heat storage is thus to overcome the intermittent and random character of solar energy by reducing the time offset and the disconnection between the most productive periods and the periods of highest demand. In particular, the heat produced in excess during periods of strong sunshine can be advantageously stored to be subsequently used at the end of the day.

In addition, heat may be derived from industrial processes involved in numerous fields. In this case, it is possible to store the heat produced in certain industries in addition to their main activity.

Heat storage is generally performed using a solid or liquid material or a combination of the two, known as storage material, which has the capacity to release or store the heat by means of a heat transfer. Such a transfer may be performed by sensible heat, i.e. by change of temperature of the material (in other words, the heat is accumulated in the material), or by latent heat, i.e. by change in the isothermal phase of the material at constant pressure (notably a solid/liquid change of a material for which the variation in volume is low).

Heat storage may also take place thermochemically by involving reversible chemical reactions generally performed at a temperature ranging from 300 to 1000° C. These reactions consume or release heat by dissociation or combination of reagents. By way of example, mention may be made of the reversible dehydration reaction of calcium hydroxide and the hydration reaction of calcium oxide.

As a result, there are at the present time mainly three processes for storing heat.

Processes directed toward transforming solar energy into heat and then in converting the heat energy obtained into electrical and mechanical energy are generally performed using a solar power collection system, a heat energy storage system and a thermodynamic conversion system. These conventional processes are typically used in concentrated thermodynamic solar power plants.

The aim of the solar power collection system is to collect solar radiation and to concentrate it on a receptor in which flows a heat-transfer fluid. During this step, the solar radiation is converted into heat energy. Such a system makes it possible to concentrate solar rays. In particular, the solar power collection system may use cylindrical parabolic reflectors, linear Fresnel reflectors, heliostats (solar rays concentrated at the top of a fixed tower) or parabolic mirrors.

The storage system makes it possible to store and to restore the excess heat energy in order notably to decorrelate the production of electrical and/or mechanical energy from the solar resource, thus overcoming the drawbacks associated with the intermittent and random nature of solar energy.

The process for storing the heat of heat energy usually takes place in three steps. A charging step, during which the heat energy, derived from the solar power collection system, is accumulated, a heat storage step, having a duration of greater or shorter length depending on the process used, and a discharging (or destocking) step corresponding to the phase of restoring the heat energy to the thermodynamic conversion system.

The thermodynamic conversion system has the aim of converting the heat energy into mechanical and electrical energy notably by means of using a thermodynamic cycle, for example a steam turbine, transforming the heat energy of the heat-transfer fluid into mechanical energy. When the thermodynamic cycle is coupled to an electrical generator, then the mechanical energy is also transformed into electrical energy.

The heat-transfer fluid circulating in the solar power collection system may be identical to or different from the fluid feeding the thermodynamic cycle. In the case where the heat-transfer fluid is different from the fluid feeding the thermodynamic cycle, the latter fluid then corresponds to a working fluid. The heat exchange between the heat-transfer fluid and the working fluid is performed using a heat exchanger. The working fluid thus accumulates the heat energy.

In the course of these processes, the heat storage system notably makes it possible to contribute toward the continuous production of electrical energy, to manage the production peaks and to adapt the production to the demand. The role of the heat storage system is thus to improve the yield of processes of this type and also the service life of the solar power facilities using them. In other words, the storage system improves the economic viability and the service life of concentrated thermodynamic solar power plants. It also makes it possible to reduce the cost of the electrical kWh. In addition, heat energy storage has the advantage of being less expensive than electrical energy storage.

In the case of a sensible heat storage system, the heat energy is stored by raising the temperature of a storage material which may be in liquid or solid form or a combination of the two. In other words, the sensible heat storage system consists in using the calorific properties of the storage material with a simple change of temperature thereof. The heat exchanges taking place between the heat-transfer fluid, which may be the working fluid, and the storage material may be performed using a heat exchanger. The storage material may also correspond to the heat-transfer fluid.

Various technologies were developed at the industrial scale in order to implement the sensible heat storage systems.

By way of example, a storage system may consist of two separate tanks filled with a storage fluid having two different temperatures, namely a “hot” tank, i.e. a tank having a constant high temperature, located at the outlet of the solar power collection system, and a “cold” tank, i.e. a tank with a constant cold temperature, located at the outlet of the thermodynamic cycle. In particular, the hot tank makes it possible to store the fluid exiting the solar power collection system in order to feed the thermodynamic cycle during the period of no sunshine. At the outlet thereof, the cooled fluid is sent to the cold tank before being redirected to the solar power collection system. Thus, during the storage phase, the cold fluid is pumped from the cold tank to the solar power collection system or the exchanger to be heated and then stored in the hot fluid tank. During the destocking phase, for its part, the hot fluid is directed toward the thermodynamic conversion system in order to restore the accumulated heat energy.

Alternatively, storage systems also exist having a single tank filled with a single fluid having two different temperatures, namely a hot temperature (corresponding to the hot fluid) and a cold temperature (corresponding to the cold fluid). Thus, the hot fluid and the cold fluid are present in the same tank with a heat gradient between the two, known as the thermocline. In other words, in the tank, the hot fluid (or the hot zone of the fluid) occupies the upper part, the cold fluid (or the cold zone of the fluid) occupies the lower part; these two parts being separated from each other by a transition region, known as the thermocline, corresponding to the heat gradient. Such a one-tank heat storage system corresponds to storage of thermocline type. In this type of system, the fluid corresponds to the heat-transfer fluid and optionally to the working fluid. In other words, preferably, the same heat-transfer fluid circulates between the solar power collection system, the thermocline-type storage system and the thermodynamic conversion system.

The use of a single tank has the advantage of reducing the number of components and also the sizing of the heat storage systems. The one-tank thermocline system is also of simplified functioning with respect to a two-tank system. This type of system is thus financially competitive.

Preferably, the storage material used in a thermocline-type storage system corresponds to a mixture of a heat-transfer fluid and of a solid storage material having a low cost price. In particular, the use of an inexpensive solid storage material, available in large amount and which may come from various sources, makes it possible to replace a large proportion of the heat-transfer fluid that may be more expensive. Thus, the cost of the thermocline-type storage system as a whole is lowered. In other words, the use of an inexpensive solid storage material emphasizes, from an economic viewpoint, the competitive nature of a one-tank thermocline system.

In addition, the solid material acts as a porous flow distributor and avoids the flow phenomena arising in one-tank thermocline-type storage systems including only the heat-transfer fluid, and which may result in the mixing of the hot and cold zones of the fluid. In other words, the presence of the solid storage material in the single tank leads to an improvement in segregation between the hot and cold zones of the heat-transfer fluid.

During the phases of charging and discharging in this type of system, the “thermocline” zone moves axially within the tank, i.e. downward and upward, respectively.

During the charging phase in this type of system, the hot fluid, coming from the solar power collection system, is introduced into the upper part of the tank, and flows downward through the solid storage material. Gradually as it circulates through the solid storage material, the fluid is cooled and the solid storage material passes from a cold temperature (i.e. a low temperature, CT) to a hot temperature (i.e. a higher temperature, HT). The cold fluid is evacuated, through the lower part of the tank, to the solar power collection system to accumulate the heat energy. The “thermocline” zone thus moves axially downward. Thus, the thermal front moves toward the bottom of the tank.

During the storage step, the hot zone of the heat-transfer fluid is located in the upper part of the tank, the cold zone of the fluid occupies the lower part; these two zones being separated by the “thermocline” region or zone.

During the discharging (or destocking) phase in this type of system, the direction of circulation of the heat-transfer fluid is reversed. The cold fluid, originating from the thermodynamic conversion system, is introduced into the tank via the lower part and circulates upward through the solid storage material. Gradually as it circulates through the solid storage material, the fluid is heated and the solid storage material passes from a hot temperature (i.e. a high temperature, HT) to a cold temperature (i.e. a lower temperature, CT). The hot fluid is then evacuated from the tank, through its upper part, to the thermodynamic conversion system to restore the heat energy. The “thermocline” zone thus moves axially upward. Thus, the thermal front moves toward the top of the tank.

During the charging and discharging phases, the solid storage material absorbs or transfers the heat of the heat-transfer fluid. This material is thus capable of storing and of restoring the heat energy of the fluid. In other words, the heat-transfer fluid makes it possible to charge and discharge the heat energy in the solid storage material.

During the destocking phase of the system, when the hot heat-transfer fluid, evacuated through the upper part of the tank, restores to the thermodynamic conversion system a temperature identical to the initial temperature of the solid storage material, i.e. the temperature of the solid storage material during the charging phase (HT temperature), then this system behaves like an ideal heat storage system. Thus, the temperature of the heat-transfer fluid will depend on the conditions of heat exchange with the solid storage material.

Furthermore, the conversion of the heat energy into electrical energy involves a first temperature at the inlet of the thermodynamic conversion system, i.e. a hot temperature (HT temperature), and a second temperature at the outlet of the system, i.e. a cold temperature (CT temperature). As a result, the limits of the thermodynamic cycle involve two temperature levels. Maintenance of these two types of temperature at constant temperatures is actively sought in order to obtain optimized functioning of the thermodynamic cycle. In other words, it is important for the system of thermocline type to lead to destocking of the heat at a constant temperature over a considerable period.

Conversely, it is also important to maintain a constant temperature during the charging phase of the storage system.

As a function of the concentrated solar power plants, the temperature levels mentioned above (CT and HT) dispensed by the heat storage systems are different and may vary within a range extending from 100° C. to 650° C.

In order to meet the requirements mentioned above, this type of system, based on a heat-transfer fluid and a solid storage material, employs quite low fluid circulation rates. This improves the heat transfer between the fluid and the solid material and minimizes the energy losses during the heat exchanges.

Moreover, it is also important to control the distribution of the heat-transfer fluid in the tank, i.e. to improve the segregation between the hot zone and the cold zone of the fluid, so as to minimize the temperature inhomogeneities, at the outlet or inlet of the tank, which may have an impact on the efficiency of the thermodynamic conversion system and thereby degrade the quality of the heat-transfer fluid.

In other words, one of the challenges of these storage systems is to control and optimize the heat exchange conditions between the heat-transfer fluid and the solid storage material in order not only to improve the electrical energy conversion yield, but also to prolong the service life of the thermocline-type storage systems. Specifically, degradation of the quality of the heat-transfer fluid in the single tank may lead in the long term to a reduction in the service life of the storage system, which has an impact on the functioning of the thermodynamic conversion system.

Moreover, the operating temperatures may also degrade the quality of the heat-transfer fluid.

Thermocline-type storage systems with optimized functioning have already been proposed.

By way of example, WO 2013/167538 describes a one-tank heat storage system including a solid storage material and a heat-transfer fluid which are distributed over several stages in fluid communication. In this system, the layers of solid material, distributed over at least two consecutive stages, are separated by a layer of heat-transfer fluid. In accordance with the proposed system, the solid storage material consists of rocks, notably of alluvial rocks, and/or of sand and, more particularly, this material is arranged in the form of a bed of blocks of rocks and of sand filling the spaces between the rocks.

The aim of this type of system is to ensure homogenization of the temperature both in the layers of heat-transfer fluid and in the layers of solid material so as to lead to a constant temperature during the charging and discharging phases.

However, there is still a real need to improve the quality of the heat-transfer fluid in a one-tank heat storage system, i.e. a system of the thermocline type, in order to control and optimize its functioning so as to prolong its service life and, consequently, the electrical energy conversion yield of the thermodynamic conversion system.

In particular, there is a need to limit the degradation of the heat-transfer fluid, notably when it is subjected to high temperatures, so as to reduce the operating costs associated with the exploitation of this type of storage system.

Thus, one of the objects of the present invention is to propose a one-tank heat storage system, i.e. a system of the thermocline type, having improved performance, notably during heat storage and destocking processes.

A subject of the present invention is thus notably a heat storage tank including at least one chemically inert solid heat storage material containing at least calcium carbonate particles.

In particular a subject of the present invention is a heat storage tank including at least one chemically inert solid heat storage material containing at least calcium carbonate particles, said calcium carbonate particles having a size distribution with a diameter d₅₀ of from 0.5 mm to 200 mm, preferably 1 mm to 100 mm, more preferentially from 2 mm to 50 mm and more preferentially from 2 mm to 40 mm.

Preferably, said heat storage tank does not contain any glass particles.

The storage material present in the heat storage tank makes it possible to limit the degradation of the heat-transfer fluid, in particular its rate of degradation when it is subjected to high temperatures.

Thus, the presence of a storage material based on calcium carbonate particles in the storage tank according to the invention makes it possible to maintain the quality of the heat-transfer fluid over time and, as a result, to reduce the operating costs associated with the exploitation of this type of storage.

In particular, the use of a storage material based on calcium carbonate particles in the storage tank according to the invention notably makes it possible to improve the quality of the heat-transfer fluid relative to a solid material consisting of rocks and/or sand under the same operating conditions, for example for a duration of 500 hours at a temperature of 340° C.

This means that the heat-transfer fluid can be partially replaced with a storage material based on calcium carbonate particles without having a negative impact on its quality.

The heat storage tank according to the invention thus has improved performance, notably during heat storage and destocking processes, which leads to optimization of the conversion of the heat energy into electrical energy during thermodynamic conversion by means of a turbine.

More particularly, the storage material based on calcium carbonate particles in the storage tank according to the invention prolongs the service life of the one-tank heat storage systems.

Moreover, the heat storage tank according to the invention conserves its economically attractive aspect.

Specifically, the storage tank according to the invention firstly entails lower operating costs than those of a tank filled solely with a heat-transfer fluid, and secondly has a longer service life than a storage tank containing a heat-transfer fluid and a solid storage material consisting of rocks and/or sand.

A subject of the invention is also the use of at least one chemically inert solid heat storage material containing at least calcium carbonate particles for limiting the rate of degradation of a heat-transfer fluid that is capable of circulating in a heat storage tank.

In particular a subject of the present invention is the use of at least one chemically inert solid heat storage material containing at least calcium carbonate particles, said calcium carbonate particles having a size distribution with a diameter d₅₀ of from 0.5 mm to 200 mm, preferably 1 mm to 100 mm, more preferentially from 2 mm to 50 mm and more preferentially from 2 mm to 40 mm, to limit the rate of degradation of a heat-transfer fluid that is capable of circulating in a heat storage tank.

In particular, the solid heat storage material based on calcium carbonate particles makes it possible to improve the thermal stability of the heat-transfer fluid.

Preferably, the solid heat storage material thus used makes it possible to limit the rate of degradation of a heat-transfer fluid in a heat storage tank over a temperature range extending from 100 to 500° C.

Thus, the solid heat storage material based on calcium carbonate particles makes it possible to improve the thermal stability of the heat-transfer fluid at temperatures that may range from 100 to 500° C.

In this way, the storage material makes it possible to prolong the functioning of the storage system at temperatures ranging from 100 to 500° C. and to optimize the functioning of the thermodynamic conversion system at such a temperature.

Another subject of the present invention is a facility for recovering free heat of industrial origin, including at least one heat storage tank containing at least one heat-transfer fluid and at least one chemically inert solid heat storage material containing at least calcium carbonate particles, preferably having a size distribution with a diameter d₅₀ of from 0.5 mm to 200 mm, preferably 1 mm to 100 mm, more preferentially from 2 mm to 50 mm and more preferentially from 2 mm to 40 mm.

Moreover, another subject of the present invention is a solar power plant including at least one heat storage tank containing at least one heat-transfer fluid and at least one chemically inert solid heat storage material containing at least calcium carbonate particles, preferably having a size distribution with a diameter d₅₀ of from 0.5 mm to 200 mm, preferably 1 mm to 100 mm, more preferentially from 2 mm to 50 mm and more preferentially from 2 mm to 40 mm.

Other characteristics and advantages of the invention will emerge even more clearly on reading the following description and examples.

In the following text, and unless indicated otherwise, the limits of a range of values are included in said range.

The expression “at least one” is equivalent to the expression “one or more”.

Heat Storage Tank

As indicated above, the heat storage tank includes at least one chemically inert solid heat storage material based on calcium carbonate particles.

For the purposes of the present invention, the term “containing at least one heat storage material” or “including at least one solid heat storage material” means that the at least one heat storage material is contained inside the heat storage tank. In other words, the heat storage material serves as filling material for the heat storage tank.

For the purposes of the present invention, the term “heat storage material” means a material that is capable of storing heat energy by varying its temperature. The amount of energy stored may generally depend on the specific heat of the material, the temperature difference that the material undergoes and the amount of the material present in the tank.

By way of example, if the temperature of the material rises from a temperature T1 to T2 for a material of mass m, said material stores a given energy by a variation in enthalpy.

For the purposes of the present invention, the term “chemically inert material” means a material that is not chemically active. In particular, the solid heat storage material does not react with the heat-transfer fluid during the phases of charging and discharging or of storage. In addition, the elements of which the heat storage material is composed do not react with each other.

The calcium carbonate particles may be in the form of calcite or aragonite, preferably in the form of calcite. The calcite may be, for example, in the form of marble.

The chemically inert solid heat storage material may include calcium carbonate particles and one or more solid elements.

The solid element(s) may be chosen as a function of their characteristics associated with the heat storage capacity and their thermal behavior, for example their mass per unit volume, heat capacity per unit mass and heat conductivity, and their compatibility with the heat-transfer fluid.

By way of example, the solid element(s) are chosen from alumina and steel in its various forms (stainless steel, etc.).

Preferably, the chemically inert solid heat storage material does not comprise any glass particles.

Preferably, the chemically inert solid heat storage material consists of calcium carbonate particles. In other words, the storage material includes only calcium carbonate particles.

In accordance with this preferential embodiment, the solid heat storage material is calcium carbonate which is in the form of particles and does not include any additional solid elements.

The calcium carbonate particles according to the invention may be in the form of spheres or flakes and/or may have totally random forms.

For the purposes of the present invention, the term “particle size” means the maximum dimension that it is possible to measure between two diametrically opposite points on the particle. The size of the calcium carbonate particles is determined by measuring their specific surface area and a criterion regarding the Biot number of less than 0.1 making it possible to satisfy the hypothesis of a thermally thin body.

Preferably, the calcium carbonate particles have a size distribution with a diameter d₅₀ ranging from 0.5 mm (millimeters) to 200 mm, preferably 1 mm to 100 mm, more preferentially from 2 mm to 50 mm and even more preferentially from 2 mm to 40 mm.

For the purposes of the present invention, the diameter d₅₀ corresponds to the value for which 50% by volume of the calcium carbonate particles have, in a particle distribution, a size less than than or equal to this diameter. The diameter is also defined as being the median of the particle distribution.

Preferentially, the calcium carbonate particles advantageously have at least two different particle sizes. This ensures satisfactory filling of the tank and reduces the free spaces for the heat-transfer fluid.

In this way, the porosity and the amount of heat-transfer fluid liable to circulate in the tank are minimized.

Each particle size thus has a diameter d₅₀ of calcium carbonate particles.

Preferably, in a particle distribution, the volume distribution is as follows: about 75% of the calcium carbonate particles having a diameter ranging from 10 mm to 30 mm and 25% of the calcium carbonate particles having a diameter ranging from 2 to 4 mm.

Such a particle size distribution contributes toward the development of a greater surface area for heat exchange between the heat-transfer fluid and the solid material.

The calcium carbonate in particulate form preferably has a weight purity of at least 50%, preferably at least 80%, preferably at least 90%, more preferentially at least 96%, more preferentially at least 97%.

The solid heat storage material may be arranged in the tank according to the invention in the form of a bed including at least the calcium carbonate particles.

In this case, the solid heat storage material is placed on a support and arranged in the form of beds. The support is adapted to mechanically support the bed of solid storage material and to allow the heat-transfer fluid to circulate.

As a variant, the solid heat storage material is distributed randomly throughout the tank without any particular arrangement, but so as to minimize the free spaces for the heat-transfer fluid.

The solid storage material is arranged so as to maximize the heat exchanges with the heat-transfer fluid that is liable to circulate in the tank.

Preferably, the storage material according to the invention is static in the heat storage tank. In other words, the storage material according to the invention does not move with the heat-transfer fluid as defined below.

Preferably, the heat storage tank also contains at least one heat-transfer fluid. In particular, the heat storage tank contains a heat-transfer fluid.

Preferably, the heat-transfer fluid and the chemically inert solid heat storage material including at least calcium carbonate particles are in direct contact inside the heat storage tank according to the invention. In other words, the heat-transfer fluid and the chemically inert solid heat storage material including at least calcium carbonate particles are not separated by a wall in the heat storage tank according to the invention.

The heat-transfer fluid may be liquid at ambient temperature or in the form of vapor, for example steam.

Preferably, the heat-transfer fluid is liquid at ambient temperature.

Preferably, the heat-transfer fluid is not water

More preferentially, the heat-transfer fluid is chosen from molten salts and oils.

The molten salts may be nitrate salts, carbonate salts or a mixture of these salts, in particular a mixture of nitrate salts.

The nitrate salts may be, for example, a mixture of sodium nitrate (NaNO₃) and of potassium nitrate (KNO₃), in particular a mixture composed of 60% by weight of sodium nitrate and 40% by weight of potassium nitrate.

The oils are notably chosen from synthetic oils, mineral oils such as those derived from petroleum, vegetable oils, in particular rapeseed oil, or a mixture thereof.

Preferably, the oils are chosen from synthetic oils, vegetable oils and a mixture thereof, more preferentially synthetic oils.

Preferably, the oils according to the invention comprise at least one aromatic ring.

More preferentially, the oils according to the invention comprise at least two rings separated by at least one carbon bond; more preferentially, the oils according to the invention comprise at least two rings separated by at least one carbon bond, at least one of said at least two rings being an aromatic ring.

Preferably, the oils according to the invention are chosen from the group consisting of:
a mixture of diphenyl ether and biphenyl,
a mixture of dibenzyltoluene isomers, sold notably under the trade name Jarytherm® DBT,
an oil corresponding to a mixture of terphenyls, sold notably under the trade name Therminol® 66, and
an oil comprising 1,2,3,4-tetrahydro(1-phenylethyl)naphthalene, sold notably under the trade name Dowtherm RP®,

more preferentially chosen from the group consisting of:
a mixture of diphenyl ether and biphenyl,
a mixture of dibenzyltoluene isomers, sold notably under the trade name Jarytherm® DBT,
an oil comprising 1,2,3,4-tetrahydro(1-phenylethyl)naphthalene, sold notably under the trade name Dowtherm RP®.

Preferably, the oils according to the invention do not comprise any terphenyl. Particularly preferably, the synthetic oils according to the invention comprise a mixture of dibenzyltoluene isomers, sold notably under the trade name Jarytherm® DBT, and more preferentially consist of a mixture of dibenzyltoluene isomers, sold notably under the trade name Jarytherm® DBT.

According to one embodiment, the heat storage tank may contain a heat-transfer fluid chosen from the oils as defined above and including at least one chemically inert solid heat storage material consisting of calcium carbonate particles.

In particular, the heat storage tank according to the invention comprises the heat-transfer fluid as defined previously.

Preferably, the heat storage tank includes a vessel filled with a heat-transfer fluid and a chemically inert solid heat storage material including at least calcium carbonate particles, a first longitudinal end, located at its upper part, and a second longitudinal end located at its lower part; the heat-transfer fluid being capable of circulating between the first longitudinal end and the second longitudinal end.

Preferably, the first longitudinal end is equipped with means for collecting and feeding the heat-transfer fluid at a first temperature.

Preferably, the second longitudinal end is equipped with means for collecting and feeding the heat-transfer fluid at a second temperature.

In accordance with the preferential embodiments described above, the first temperature is higher than the second temperature.

Preferably, the first longitudinal end is equipped with means for collecting and feeding the heat-transfer fluid at a first temperature ranging from 110° C. to 650° C. and the second longitudinal end is equipped with means for collecting and feeding the heat-transfer fluid at a second temperature ranging from 100° C. to 640° C.; the first temperature being higher than the second temperature.

In accordance with another embodiment, the heat storage tank according to the invention may have a structure as described in patent application FR 2990502.

Use of the Storage Material

As indicated above, the present invention also relates to the use of at least one chemically inert solid heat storage material containing at least calcium carbonate particles for limiting the rate of degradation of a heat-transfer fluid that is capable of circulating in a heat storage tank as defined previously.

In particular, the solid heat storage material makes it possible to limit the rate of degradation of a heat-transfer fluid in a heat storage tank as defined previously, i.e. filling and/or circulating in said tank.

The solid heat storage material is as defined above.

Preferably, the solid heat storage material consists of calcium carbonate particles, i.e. it does not comprise any additional solid elements other than the calcium carbonate particles.

The heat-transfer fluid is as defined above. Preferably, the fluid is liquid at ambient temperature and is chosen from oils.

More preferentially, the heat-transfer fluid is an oil, preferably a synthetic oil, as defined above.

Preferably, the solid heat storage material thus used makes it possible to limit the rate of degradation of the heat-transfer fluid in a temperature range extending from 100 to 500° C.

Facility for Recovering Free Heat of Industrial Origin

The present invention also relates to a facility for recovering free heat of industrial origin, comprising a heat storage tank as defined previously.

The term “free heat” refers to a production of heat derived from a production site. Consequently, it is heat which does not constitute the main subject of said site.

Solar Power Plant

Similarly, the present invention relates to a solar power plant containing a storage tank as defined previously. Preferably, the storage tank contains a heat-transfer fluid as defined above.

Preferably, the solar power plant is a concentrated thermodynamic plant.

The solar power plant also includes a solar power collection system and a thermodynamic cycle, notably a steam turbine.

Preferably, the first longitudinal end, provided with means for collecting and feeding the heat-transfer fluid, and the second longitudinal end, provided with means for collecting and feeding the heat-transfer fluid, are connected to the thermodynamic cycle, in particular a steam turbine.

Other features and advantages of the invention will emerge on detailed examination of an embodiment taken as a nonlimiting example of a heat storage tank according to the invention and illustrated by the appended drawings, in which:

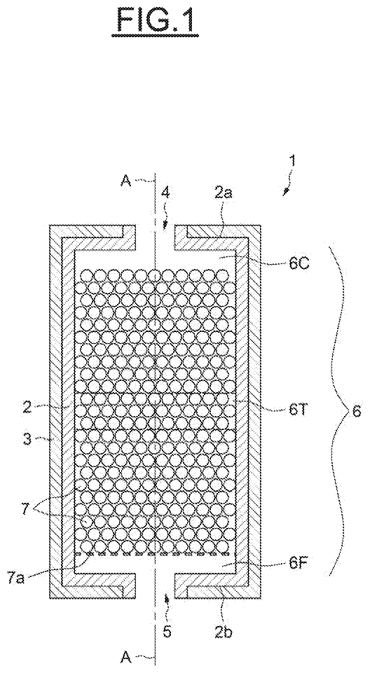

FIG. 1 is a view in longitudinal cross-section of a heat storage tank according to the invention including a vessel filled with a heat-transfer fluid and a solid heat storage material,

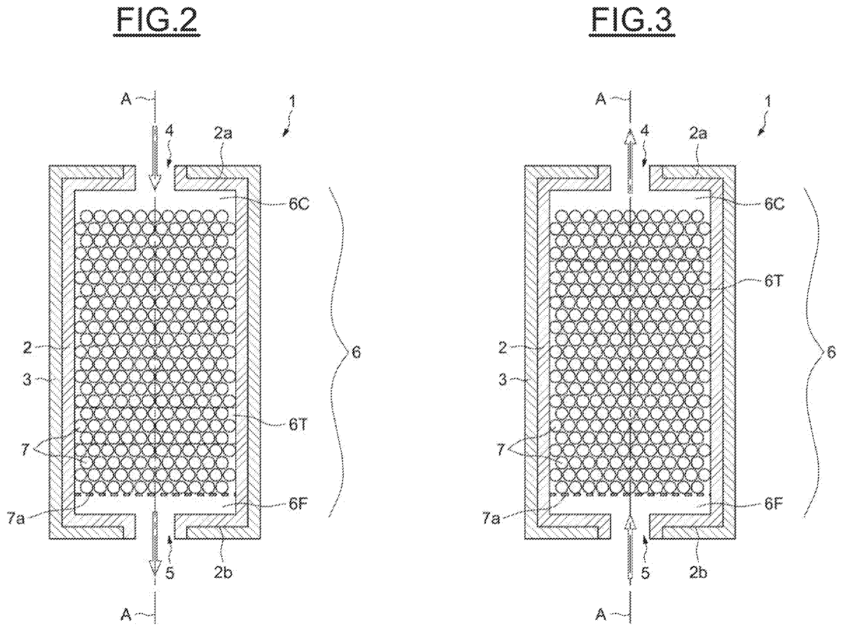

FIG. 2 schematically shows the heat storage tank according to the invention during a charging phase,

FIG. 3 schematically illustrates the heat storage tank according to the invention during a discharging phase (destocking step).

FIG. 1 represents a heat storage tank 1 according to the invention made in accordance with one embodiment.

The tank 1 includes a vessel 2 having a parallelepipedal shape with a vertically oriented longitudinal axis A-A. As a variant, the vessel 2 may have an oblong shape, in particular a cylindrical shape, having a vertically oriented longitudinal axis A-A.

Also as a variant, the vessel 2 corresponds to a ferrule having two domed ends.

In accordance with FIG. 1, the vessel 2 is preferably thermally insulated with an envelope 3 made using an insulating material.

Preferably, the envelope 3 is in contact with the vessel 2 so as to cover both the sidewalls and the upper and lower parts of the vessel 2. The envelope 3 notably has the same shape as the vessel 2.

The vessel 2 has a first upper longitudinal end 2a equipped with an orifice 4 acting as inlet or outlet for a fluid as a function of the charging and discharging phases of the system, and a second lower longitudinal end 2b equipped with an orifice 5 acting as an inlet or outlet for a fluid as a function of the charging and discharging phases of the system.

The orifices 4 and 5 thus function to feed and/or collect the heat-transfer fluid that is liable to fill the vessel 2. The orifices 4 and 5 may be equipped with fluid feed and collection means.

The insulating envelope 3 is also open at the orifices 4 and 5.

The vessel 2 is filled with a heat-transfer liquid 6, preferably a synthetic oil as defined above, and a chemically inert solid heat storage material 7, consisting solely of calcium carbonate particles. The calcium carbonate particles 7 rest on a support 7a which serves to retain them while at the same time allowing the passage of the heat-transfer liquid 6 throughout the vessel 2.

The support 7a may be made as a single piece or may be formed from several pieces to facilitate its mounting in the vessel 2.

In FIG. 1, the calcium carbonate particles 7 have an identical diameter. However, according to another preferential embodiment, the carbonate particles 7 have different sizes.

The heat-transfer liquid 6 occupies, along the longitudinal axis A-A, the upper part of the vessel 2 at a first temperature (known as the HT temperature), the lower part of the tank at a second temperature (known as the CT temperature), the median part of the vessel 2 corresponding to an intermediate region known as the thermocline, intercalated between the upper part and the lower part. The first temperature (HT) is higher than the second temperature (CT).

The heat-transfer liquid 6 thus includes a hot zone 6C (at a temperature HT) located in the upper part of the vessel 2, a cold zone 6F (at a temperature CT) located in the lower part of the vessel 2 and an intermediate zone 6T intercalated between the hot zone 6C and the cold zone 6F, known as the thermocline and constituting a heat gradient.

In other words, the heat-transfer liquid 6 is thermally stratified in the vessel 2, these strata forming layers having different temperatures which are superposed on each other, from the coldest zone to the hottest zone along the longitudinal axis A-A.

The temperature HT may range from 110° C. to 650° C. and the temperature CT may range from 100° C. to 640° C.

The temperature in the intermediate zone 6T is below the temperature HT of the hot zone 6C and above the temperature CT of the cold zone 6F.

Preferably, the heat-transfer fluid 6 is an oil, in particular a synthetic oil, corresponding to a mixture of dibenzyltoluene isomers, notably the product sold under the trade name Jarytherm® DBT.

FIG. 1 represents the storage phase, i.e. the step during which the heat-transfer liquid 6 is stored in the tank 1 and the thermocline is in equilibrium at the center of the tank 1.

As indicated above, FIG. 2 describes schematically the storage tank according to the invention, notably illustrating the direction of circulation of the heat-transfer liquid 6 in the vessel 2 during the charging phase.

During this charging phase, the hot heat-transfer liquid 6, coming from a solar power collection system (not shown in FIG. 2), is introduced into the upper part 2a by means of the orifice 4 and flows downward (along the longitudinal axis A-A) through the calcium carbonate particles 7, inducing a downward shift of the thermocline 6T. During its circulation through the calcium carbonate particles 7, the heat-transfer liquid 6 is cooled to reach the temperature CT and is evacuated through the orifice 5 of the lower part 2b of the tank 1 to the solar power collection system.

FIG. 2 shows, by means of arrows, the direction of circulation of the heat-transfer liquid 6 through the tank 1, i.e. from the top downward along the longitudinal axis A-A. The intermediate zone 6T moves axially downward during the charging phase.

As indicated above, FIG. 3 illustrates schematically the storage tank according to the invention, notably illustrating the direction of circulation of the heat-transfer liquid 6 in the vessel 2 during the discharging (or destocking) phase.

During this discharging phase, the cold heat-transfer liquid 6, coming from a thermodynamic conversion system (not shown in FIG. 3), is introduced through the orifice 5 of the lower part 2b of the vessel 2 and flows upward (along the longitudinal axis A-A) through the calcium carbonate particles 7, inducing an upward shift of the thermocline 6T. During its circulation through the calcium carbonate particles 7, the heat-transfer liquid 6 is heated to reach the temperature HT and is evacuated through the orifice 4 of the upper part 2a of the tank 1 to the thermodynamic conversion system, namely the turbine.

FIG. 3 shows, by means of arrows, the direction of circulation of the heat-transfer liquid through the tank 1, i.e. from the bottom upward along the longitudinal axis A-A. The intermediate zone 6T moves axially upward during the discharging phase.

FIGS. 1 to 3 thus describe an embodiment of a one-tank heat storage system which may contain a heat-transfer fluid and containing at least one solid heat storage material comprising at least calcium carbonate particles.

As a variant, the tank 2 may be divided into several compartments superposed along the longitudinal axis A-A, each compartment including the calcium carbonate particles 7 arranged in the form of a bed, covered with the heat-transfer liquid 6 which is capable of circulating through all of the compartments.

Again as a variant, the calcium carbonate particles 7 may be in the form of spheres or flakes and/or may have totally free forms.

The example that follows relates to tests of thermal stability of the heat-transfer fluid as a function of the nature of the solid storage material employed.

### Example of Thermal Stability

In this example, the thermal stability of a synthetic oil sold under the trade name Jarytherm® DBT by the company Arkema was studied, in a heat storage tank, alone or in the presence of various types of chemically inert solid heat storage materials at a temperature of 340° C. for a time of 500 hours or 2000 hours.

The amount of undegraded synthetic oil was measured at the end of the study period.

The results are collated in the following table:

| | Content of |
|---|---|
| Operating conditions | DBT in the oil |
| Fresh oil | 98 |
| Oil alone/500 hours at 340° C. | 92 |
| Oil + calcium carbonate particles/ | 90.6 |
| 500 hours at 340° C. | |
| Oil + rock/500 hours at 340° C. | 83.4 |
| Oil + sand/500 hours at 340° C. | 81.2 |
| Oil alone/2000 hours at 340° C. | 80.8 |
| Oil + calcium carbonate particles/ | 79.7 |
| 2000 hours at 340° C. | |

The results show that the content of DBT in the oil is significantly higher with calcium carbonate particles relative to that measured in the presence of rocks or sand after a time of 500 hours at a temperature of 340° C.

1. A heat storage tank comprising at least one chemically inert solid heat storage material containing at least calcium carbonate particles, wherein the calcium carbonate particles have a size distribution with a diameter d₅₀ of from 0.5 mm to 200 mm.

2. The heat storage tank as claimed in claim 1, not containing any glass particles.

3. The heat storage tank as claimed in claim 1, further comprising at least one heat-transfer fluid (6).

4. The heat storage tank as claimed in claim 4, wherein the heat-transfer fluid is liquid at ambient temperature.

5. The heat storage tank as claimed in claim 3, wherein the heat-transfer fluid is chosen from molten salts and oils.

6. The heat storage tank as claimed in claim 5, wherein the molten salts are chosen from nitrate salts, carbonate salts or a mixture thereof.

7. The heat storage tank as claimed in claim 5, wherein the oil is chosen from synthetic oils, mineral oils, vegetable oils and mixtures thereof.

8. The heat storage tank as claimed in claim 5, wherein the oil comprises at least one aromatic ring.

9. The heat storage tank as claimed in claim 5, wherein the oil comprises at least two rings separated by at least one carbon bond, at least one of said at least two rings being an aromatic ring.

10. The heat storage tank as claimed in claim 5, wherein the oil is chosen from the group consisting of:
a mixture of diphenyl ether and biphenyl,
a mixture of dibenzyltoluene isomers, sold notably under the trade name Jarytherm® DBT,
an oil corresponding to a mixture of terphenyls, sold notably under the trade name Therminol® 66, and
an oil comprising 1,2,3,4-tetrahydronaphthalene, sold notably under the trade name Dowtherm RP®.

11. The heat storage tank as claimed in claim 5, wherein the oil does not comprise any terphenyl.

12. The heat storage tank as claimed in claim 3, wherein the heat-transfer fluid and the chemically inert solid heat storage material including at least calcium carbonate particles are in direct contact.

13. The heat storage tank as claimed in claim 1, wherein it includes a vessel filled with a heat-transfer fluid and a chemically inert solid heat storage material including at least calcium carbonate particles, a first longitudinal end, located at its upper part, and a second longitudinal end located at its lower part; the heat-transfer fluid being capable of circulating between the first longitudinal end and the second longitudinal end.

14. The heat storage tank as claimed in claim 13, in which the first longitudinal end is equipped with means for collecting and feeding the heat-transfer fluid at a first temperature ranging from 110° C. to 650° C. and the second longitudinal end is equipped with means for collecting and feeding the heat-transfer fluid at a second temperature ranging from 100° C. to 640° C.; the first temperature being higher than the second temperature.

15. A facility for recovering free heat of industrial origin, comprising a heat storage tank as claimed in claim 1.

16. A solar power plant including at least one heat storage tank as claimed in claim 1.

17. The use of at least one chemically inert solid heat storage material including at least calcium carbonate particles for limiting the rate of degradation of a heat-transfer fluid that is capable of circulating in a heat storage tank as defined in claim 1.

18. A method of circulating a heat transfer fluid, comprising circulating a heat transfer fluid in the heat storage tank as defined in claim 1.
